(19) United States
(12) Patent Application Publication
(10) Pub. No.: US 2014/0138120 A1
(43) Pub. Date: May 22, 2014

(54) CONDUCTOR FOR ELECTRIC WIRE

(71) Applicant: Yazaki Corporation, Tokyo (JP)

(72) Inventor: Tsuyoshi Watanabe, Susono-shi (JP)

(73) Assignee: YAZAKI CORPORATION, Tokyo (JP)

(21) Appl. No.: 14/164,510

(22) Filed: Jan. 27, 2014

Related U.S. Application Data
(63) Continuation-in-part of application No. PCT/JP2012/004648, filed on Jul. 23, 2012.

(30) Foreign Application Priority Data
Jul. 28, 2011 (JP) 2011-165639

(51) Int. Cl. H01B 1/02

(52) U.S. Cl. CPC H01B 1/026
USPC 174/126.1

(57) ABSTRACT

A conductor for an electric wire having high-strength and high electric conductivity is provided. The conductor includes copper alloy in which a plurality of two-phases is dispersed in mother phase consisting of copper, the two-phases being made of metal crystal. The metal crystal is formed in a needle shape, and oriented in a longitudinal direction of the conductor for the electric wire. The conductor is able to reduce the diameter and weight, and to be used in ultrafine electric wire.

### TECHNICAL FIELD

The present invention relates to a conductor for an electric wire which has high strength and high electric conductivity, and can reduce the diameter of the conductor and the weight thereof. The conductor of the present invention can be used as a conductor of an extra fine for use in a wiring harness.

### BACKGROUND ART

In regard to a copper alloy conductor, it is required to increase material strength of conductive material so as to reduce the use of conductive material, the diameter of an electric wire and the weight thereof.

As a method of increasing strength of conductive material, there are mainly five methods, more specifically, work hardening (dislocation strengthening), grain refinement strengthening, solid-solution strengthening, precipitation strengthening, and dispersion strengthening.

In such methods, when the conductor is applied to a field requiring high conductive property, it is considered that the method of solid-solution strengthening can not be used generally because of electric resistance increase. Furthermore, according to the work hardening and grain refinement strengthening, strength is improved by giving a large strain to material. For this reason, heat resistance property is low, and strength is greatly decreased in a hot environment. As a result, enough strength can not be provided in the electric wire field for performing wire drawing processing. Additionally, in the case of precipitation strengthening disclosed in the Patent Document 1 or Patent Document 2, precipitation element is dispersed by heat treatment in tissue. Therefore, relatively-high electric conductivity characteristic can be obtained, but sufficiently-high strength can not be provided so as to perform heat treatment. Also, in the case of dispersion strengthening, generally, non-metal dispersed material such as aluminum oxide (Al₂O₃) is dispersed in mother phase consisting of metal. However, in the case of extra fine conductor, dispersed material is relatively large foreign material, and it is at high risk of generating destruction as a starting point from an interface between the base material and the dispersed material.

### CITATION LIST

### Patent Literature

[PTL 1]

Patent Document 1: Japanese Published Application No. 2009-185320

Patent Document 2: Japanese Published Application No. 2001-295011

### SUMMARY OF INVENTION

### Technical Problem

An object of the present invention is to provide a conductor for electric wire having high strength and high electric conductivity. In the conductor for the electric wire of the present invention, conventional problems described above can be improved. Thus, the conductor of present invention can reduce the diameter of the electric wire and the weight thereof, and can be applied to an extra fine wire.

### Solution to Problem

In order to attain the above object, the present invention provides a conductor for electric wire includes copper alloy in which a plurality of two-phases is dispersed in mother phase consisting of copper, the two-phases being made of metal crystal. The metal crystal is formed in a needle shape, and oriented in a longitudinal direction of the conductor for the electric wire.

Furthermore, the conductor for the electric wire of the present invention the two-phases which are dispersed in the mother phase when the copper alloy is cast or when the copper alloy is heated so as to process wire are formed in the needle shape by wire drawing of the copper alloy.

Furthermore, the conductor for the electric wire of the present invention the conductor for the electric wire is obtained in a manner that copper to which an element forming eutectic crystal having a melting point higher than a melting point of copper together with copper and/or an element having a melting point higher than the melting point of the copper is added is cast, and then is processed by wire drawing.

Furthermore, the conductor for the electric wire of the present invention the electric wire is formed by wire drawing, and the distance between the needle-shaped two-phases made of metal crystal in the mother phase is equal to or lower than 0.25 micrometer.

### Advantageous Effects of Invention

According to the conductor for the electric wire of the present invention, strength is high, and electric conductivity is high. Thus, the conductor for the electric wire in which the diameter and the weight can be reduced and applied to an extra fine wire can be provided.

Furthermore, according to the conductor for the electric wire of the present invention, the two-phases are formed in the needle shape. Thus, the conductor of the present invention has more high strength.

Additionally, according to the conductor for the electric wire of the present invention, high electric conductivity of 70% IACS (International Annealed Copper Standard) can be achieved.

Furthermore, since the conductor for the electric wire of the present invention has tension strength of 900 MPa. Thus, high strength can be achieved.

### BRIEF DESCRIPTION OF DRAWINGS

[FIG. 1]

FIG. 1 is a state diagram of binary alloy of copper and chromium.

[FIG. 2A]

FIG. 2A is a model diagram showing a dispersed two-phase in the alloy in which a plurality of two-phases are made of metal crystal, and dispersed in mother phase consisting of copper before wire drawing.

[FIG. 2B]

FIG. 2B is a model diagram showing a state oriented in a longitudinal direction (a double-headed arrow direction shown in FIG. 2B) of the conductor for the electric wire which includes an alloy in which a plurality of the two-phases are made of metal crystal, and are dispersed in mother phase consisting of copper, the metal crystal being a needle shape after wire drawing

[FIG. 3A]

FIG. 3A shows scanning electron micrograph of the conductor for the electric wire of the present invention in cross-section of a longitudinal direction, and is a scanning electron micrograph of the conductor for the electric wire made of alloy in which a plurality of two-phases consisting of a needle-shaped chromium-copper alloy crystal are dispersed.

[FIG. 3B]

FIG. 3B shows scanning electron micrograph of the conductor for the electric wire of the present invention in cross-section of a longitudinal direction, and is a scanning electron micrograph of the conductor for the electric wire made of alloy in which a plurality of two-phases consisting of a needle-shaped niobium-copper alloy crystal are dispersed.

### DESCRIPTION OF EMBODIMENTS

A conductor for electric wire of the present invention can be used as a conductor of common electric wire. In particular, an extra fine conductor such as a conductor having a cross-sectional area being equal to or lower than 0.05 mm² (0.05 sq) (the diameter of element wire is 0.25 mm) can be preferably used. In such conductor, when electric wires are used, minimum breaking strength is required. For this reason, it is desired that tension strength is equal to or higher than 900 MPa, and conductive property is equal to or higher than 70% IACS. In general art, since the diameter of electric wire is thin, enough strength is not obtained. However, in the conductor for the electric wire of the present invention, enough strength can be obtained, because the conductor for the electric wire of the present invention is composed of alloy in which the two-phases made of metal crystal are dispersed in mother phase consisting of copper. The metal crystal is a needle shape, and oriented in a longitudinal direction of the conductor for the electric wire. Thus, the conductor for the electric wire can respond to its requirement.

The mother phase can be formed by using common pure copper, for example, C1020 having degree of purity of 99.95 wt %.

The two-phases are dispersed when a copper alloy is cast or when the copper alloy is heated so as to process wire. At this time, the two-phases are formed in the needle shape by wire drawing of the copper alloy.

Such the two-phases can be obtained by adding an element forming eutectic crystal having a higher melting point than a melting point of copper together with the copper and/or metal crystal having a higher melting point than copper to copper, and by casting.

The element forming eutectic crystal which has the melting point higher than the melting point of copper with the copper includes chromium, vanadium, or niobium and the like. Preferably, the element may be chromium and niobium because the eutectic crystal having a feasible melting point range can be formed for practical use.

Furthermore, metal elemental crystal having a body-centered cubic lattice structure having a higher melting point than the copper includes niobium, chromium, yttrium, tantalum, tungsten, iron and so on. Also, in metal crystal except metal elemental crystal having the body-centered cubic lattice structure, that is, the metal elemental crystal having a face-centered cubic lattice structure or a hexagonal close-packed lattice structure, solid solubility limit is high against copper, or strength and electric conductivity may not be sufficiently obtained so as to form copper and intermetallic compound.

As the element constructing metal elemental crystal, it is preferred that the inciting point is higher as possible than the melting point of copper, and an amount of solid-solution is small. Additionally, the amount of solid-solution may be large at high temperature, and may be low at low temperature.

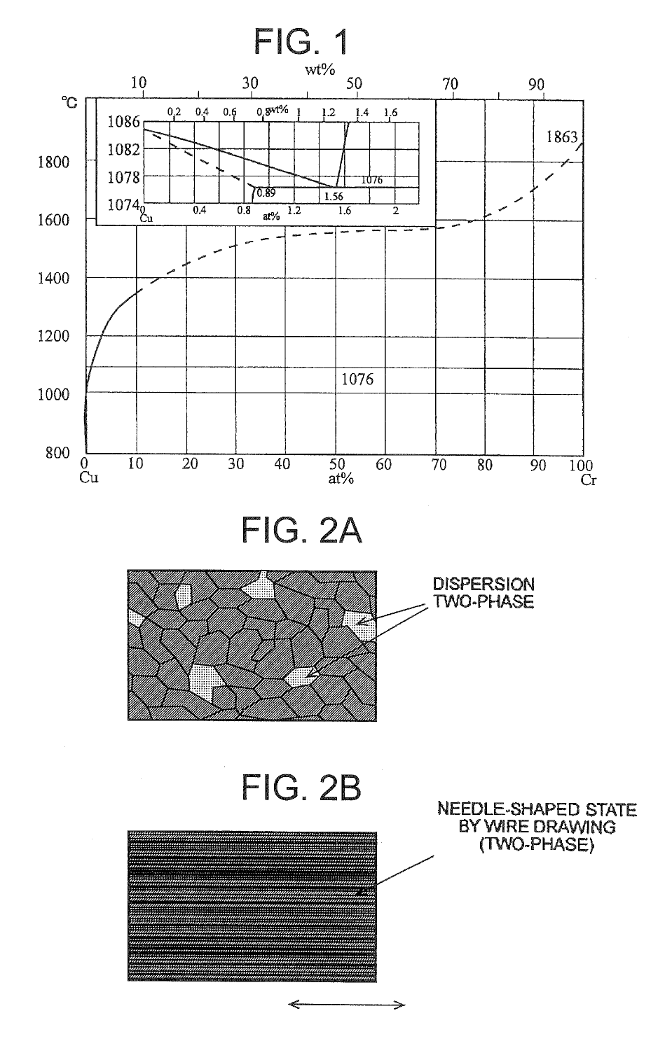

In a case of chromium forming crystal having the body-centered cubic lattice structure, as a state diagram of copper and binary alloy shown in FIG. 1, a melting point of chromium is over 1863 degrees Celsius. That is, the melting point of chromium is more than 800 degrees Celsius higher than 1083 degrees Celsius being a melting point of copper. Furthermore, the amount of the solid solution to copper is less than 1 at %, and chromium and copper can not be almost made into a solid solution at 800 degrees Celsius. In addition, solid solution quantity of copper is a very low against chromium. For this reasons, when chromium is added to copper and melted, structure, in which chromium-copper alloy having composition similar to pure chromium as two-phase is dispersed, is formed in mother phase similar to pure copper after cooling as shown in FIG. 2A.

Regarding to an amount of dispersion of two-phase, it is preferable to set within the range from 1 at % or more to 10 at % or less so as to increase electric conductivity to a satisfactory range while maintaining high-strength.

Also, casting is required to perform above a temperature in which eutectic crystal is generated when element forming the eutectic crystal having a melting point higher than a melting point of copper with copper is added.

Cooling after casting may be performed at a relatively fast speed, for example, 30 degrees Celsius/sec or more, because structure dispersed as two-phase is readily formed.

After cooling, wire drawing process is performed. This can be performed in common manner using a die. By the wire drawing, the two-phase in mother phase is extended into a needle shape, and oriented as shown in FIG. 2B.

Chromium of 5 at % is added against copper, and they are melted at 1600 degrees Celsius. Thereafter, alloy is cooled to room temperature at 30 degrees Celsius/sec. A wire drawing is applied to the alloy with reduction of area (a cross-sectional decrease ratio from wire before wire drawing to wire after wire drawing) of 99.75%. As a result, the distance between the needle-shaped two-phases made of metal crystal in mother phase can be equal to or lower than 0.25 micrometer. At this time, the conductor can have tension strength of 900 MPa, and electric conductivity EC of 70% IACS.

### Example

Example of the conductor for electric wire of the present invention will be explained below.

C1020 is used as base material of pure copper.

Niobium of metal element and chromium having body-centered cubic lattice structure are respectively added to the C1020 until they becomes 1.8 at %. Next, they are respectively heated to a temperature of 1600 degrees Celsius, and cast. Thereafter, they are respectively cooled to room temperature at 30 degrees Celsius/sec. As a result, each alloy ingot in which the diameter is 2 cm, and the length is 7 cm is obtained.

Thereafter, each alloy ingot is drawn by using a die so that a rate of reduction of area becomes 99.91%. Each the conductor in which the diameter in cross-section is 0.14 mm is obtained.

According to an observation of each structure with a scanning electron microscope (SEM), a needle-shaped crystal (two-phase) has been formed in mother phase. The quotient (average) of the length and diameter of the crystal are 100-150. The distance between the needle-shaped two-phases has been 0.25 micrometer.

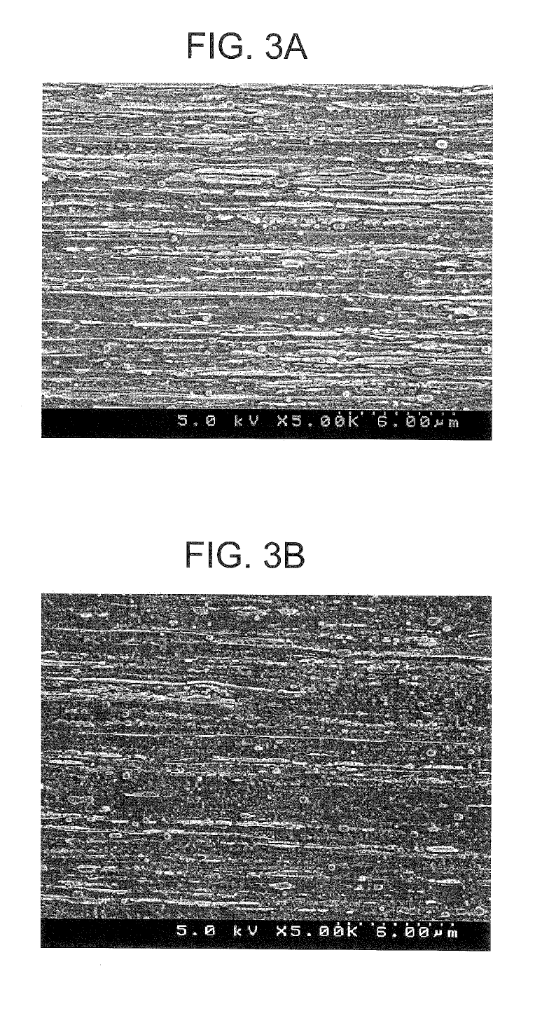

FIG. 3A shows a cross-sectional scanning electron micrograph in a longitudinal direction of the conductor for the electric wire composed of alloy in which a plurality of two-phases is dispersed, the two-phase being made of the needle-shaped chromium-copper alloy crystal. Also, FIG. 3B shows a cross-sectional scanning electron micrograph in a longitudinal direction of the conductor for the electric wire composed of alloy in which a plurality of two-phases two-phase is dispersed, the two-phase being made of the needle-shaped niobium-copper alloy crystal.

Regarding to those conductors, that is, copper-niobium alloy conductor and copper-chromium alloy conductor, and C1020, tension strength and electric conductivity were respectively measured in reference to JIS (Japanese Industrial Standards) Z2001 and JIS Z2241.

Furthermore, in the same way as the copper-chromium alloy conductor, alloy conductors have been obtained by using nickel and tin instead of copper so that alloy conductor including nickel becomes 5 at %, and alloy conductor including tin becomes 0.5 at %. Those conductors are respectively measured in the above same manner. Those results are shown in Table 1.

TABLE 1

| | | ELECTRIC |
|---|---|---|
| | TENSION | CONDUCTIVITY |
| SAMPLE | STRENGTH (MPa) | (% IACS) |
| C1020 | 480 | 99 |
| COPPER-CHROMIUM | 900 | 70 |
| ALLOY CONDUCTOR | | |
| COPPER-NIOBIUM | 900 | 75 |
| ALLOY CONDUCTOR | | |
| COPPER-NICKEL | 680 | 3 |
| ALLOY CONDUCTOR | | |
| COPPER-TIN | 850 | 30 |
| ALLOY CONDUCTOR | | |

As will be noted from the Table 1, the conductor of the present invention has high tension strength and high electric conductivity, and thus the conductor is an excellent conductor.

1. A conductor for an electric wire comprising:
copper alloy in which a plurality of two-phases is dispersed in mother phase consisting of copper, the two-phases being made of metal crystal,
wherein the metal crystal is formed in a needle shape, and oriented in a longitudinal direction of the conductor for the electric wire, and
wherein the electric wire is formed by wire drawing, and the distance between the needle-shaped two-phases made of metal crystal in the mother phase is equal to or lower than 0.25 micrometer.

2. The conductor for the electric wire as claimed in claim 1, wherein the two-phases which are dispersed in the mother phase when the copper alloy is cast or when the copper alloy is heated so as to process wire are formed in the needle shape by wire drawing of the copper alloy.

3. The conductor for the electric wire as claimed in claim 1, wherein the conductor for the electric wire is obtained in a manner that copper to which an element forming eutectic crystal having a melting point higher than a melting point of copper together with copper and/or an element having a melting point higher than the melting point of the copper is added is cast, and then is processed by wire drawing.

4. The conductor for the electric wire as claimed in claim 2, wherein the electric wire is formed by wire drawing, and the distance between the needle-shaped two-phases made of metal crystal in the mother phase is equal to or lower than 0.25 micrometer.

5. The conductor for the electric wire as claimed in claim 3, wherein the electric wire is formed by wire drawing, and the distance between the needle-shaped two-phases made of metal crystal in the mother phase is equal to or lower than 0.25 micrometer.
